(19) United States
(12) Patent Application Publication
(10) Pub. No.: US 2009/0112611 A1
(43) Pub. Date: Apr. 30, 2009

(54) Interactive fundraising with funder rules

(76) Inventor: Stephen J. Brown, Woodside, CA (US)

Correspondence Address: LUMEN PATENT FIRM, 2345 YALE STREET, SECOND FLOOR, PALO ALTO, CA, 94306, US

(21) Appl. No.: 12/150,218

(22) Filed: Apr. 25, 2008

Related U.S. Application Data
(60) Provisional application No. 61/000,459, filed on Oct. 26, 2007.

(51) Int. Cl. G06Q 90/00

(52) U.S. Cl. 705/1

(57) ABSTRACT

Project-based interactive fundraising with funder rules is provided. A fundraising application is accessible by multiple online users for creating projects to be funded and for funding created projects. Projects can include project requirements, such as a target funding minimum. Online users can select created projects and establish funder rules to determine conditions to fund the selected projects. The project requirements and funder rules are processed to determine whether or not funds can be released to the projects or returned to the selecting users. The funder rules give funding users direct control over the project fundraising. The processed funder rules provide information on current and anticipated funding levels and can be used to find approximate optimal conditions to attain high funding levels and increase the likelihood of success to fund a project.

### CROSS-REFERENCE TO RELATED APPLICATIONS

This application claims priority from U.S. Provisional Patent Application 61/000,459 filed Oct. 26, 2007, which is incorporated herein by reference in its entirety.

### FIELD OF THE INVENTION

The invention relates generally to interactive fundraising. More particularly, the present invention relates to project-directed online fundraising with rules.

### BACKGROUND

Fundraising has traditionally required a combination of personal requests, direct-mail asks, telephone solicitations, special events, etc. Use of the Internet has introduced a significant breadth of complexity, strategies, and advantages. In particular, existing online or Internet-based fundraising allow fundraisers to reach a larger number and variety of potential funders.

Many charities and non-profit organizations are increasingly using the Internet as a means to raise funds.

However, existing online fundraising practices typically simply place traditional fundraising practices onto a web format, such as using a ‘Donate Now’ button, where simple web-forms are available to capture credit card gifts. Generally, donations are made to organizations and at the time of the donation, the donors are generally unaware of how the donated funds will be used. Furthermore, some online fundraising practices rely on intermediaries to pass on the donated funds. The use of intermediaries generally reduces the usable donation amounts as the intermediaries take a fraction of the donated amount.

More sophisticated online fundraising websites, such as GlobalGiving.com and DonorsChoose.org, have been established for pooling multiple donations to fund certain projects. However, existing online fundraising websites typically only provide donors with the option of whether to donate or not; the existing websites typically lack functions that enable donors to impose specific funding conditions. Also, existing online fundraising websites do not provide up-to-date information regarding the success or failure of the donated funds. Potential donors are often hesitant to donate due to lack of information and donor control. In particular, donors generally do not know the significance of their donations to a fundraising campaign and the probabilities of success of the campaigns. Furthermore, donations are generally not returned to the donors when a campaign fails.

The present invention addresses at least the difficult problems of fundraising and advances the art with interactive fundraising techniques.

### SUMMARY OF THE INVENTION

The present invention is directed to project-based online fundraising with funder rules. An application server operates the internet-based fundraising application for a plurality of users. The fundraising application includes a project creation function and a funding function. The project creation function allows each of the online users to create one or more projects to be funded, where the created projects include project requirements, such as a target funding minimum. The funding function allows each of the online users to select one or more created projects and establish one or more funder rules directed to the selected projects. Optionally, a function is provided for funders to enter financial account information to facilitate transfers of funds. By processing the funder rules of a project, the current and anticipated funding levels of the project can be determined and compared with the target funding minimum. Based on the comparison of the funding levels and the target funding minimum, a fund transfer function is used to at least partially fund the selected project, where the funds are from the users who selected the project.

The project requirements can include a funding minimum, a total funding goal, a target start date, and a latest start date. Online users can also create projects with project requirements, including a draw frequency, a draw amount, and a project duration. The funder rules can include a commitment, a payment frequency, a payment duration, a start funding date, a project minimum, a project maximum, and a project fund by date. The funder rules provide potential funders with control to establish desirable conditions for funding a project. In a preferred embodiment, the funder rules directed to a project and the project requirements of the same project can be processed to find approximate optimal conditions to reach the funding minimum.

In a preferred embodiment, the application server manages an escrow account for at least one of the selected projects. The escrow account holds a funding commitment of the users who selected the project. Some or all of the funding commitment is released to the project if the project is successfully funded, else, the funding commitment is returned to the users who selected the project.

A display function can be provided for displaying the current and anticipated funding levels of one or more of the created projects. Optionally, a list of created projects is provided and is viewable by the online users, where the funding function allows each of the users to select one or more projects from the list to fund. The online users can also use a commenting function to make comments regarding one or more of the created projects.

### BRIEF DESCRIPTION OF THE FIGURES

The present invention together with its objectives and advantages will be understood by reading the following description in conjunction with the drawings, in which:

FIG. 1 shows an example of a project creator PC creating a project P to be funded with project funding requirements PFR and funding users F₁-F_{N} establishing funder rules FR₁-FR_{N} and funding the project P according to the present invention.

FIG. 2 shows a flow chart of an example project life according to the present invention.

FIG. 3 shows examples of project funding requirements according to the present invention.

FIG. 4 shows examples of funder rules according to the present invention.

FIG. 5 shows a flow chart of an example of how project success is determined based on project funding requirements and funder rules according to the present invention.

FIG. 6A shows an example bar chart of received funds according to the present invention.

FIG. 6B shows an example bar chart of received and anticipated funds according to the present invention.

FIG. 7A shows an example funding level graph for a project with multiple draws according to the present invention.

FIG. 7B shows an example funding level bar chart for a project with multiple draws according to the present invention.

FIG. 8 shows an example of a user interface with a project list 840, a project searching function 820, and a commenting function 830 according to the present invention.

### DETAILED DESCRIPTION OF THE INVENTION

Online fundraising has the potential to effectively reach out to a large number of funders for a variety of organizations and causes. However, current online fundraising techniques typically simply replace more traditional offline techniques of fundraising for organizations and do not give the potential funders much control over funding conditions. Below is a detailed description of interactive fundraising with funder rules in an online environment of a plurality of users.

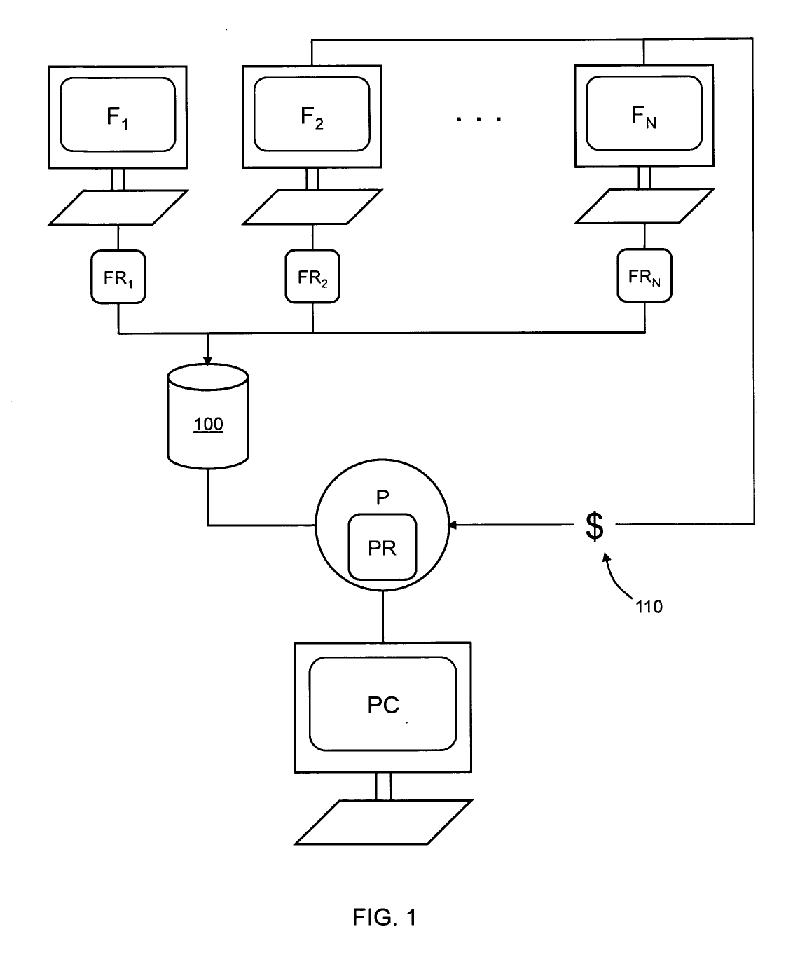

FIG. 1 shows an example of project-based fundraising for multiple online users connected over a network, such as the Internet or a local area network. An application server 100 operates an internet-based fundraising application accessible by the online users. The fundraising application 100 includes a project creation function and a funding function. The project creation function allows each of the users to be a project creator PC for creating a project P to be funded. The project P can be any type of project that requires funding, including charitable projects, not-for-profit projects, for-profit projects, company funding projects with investors, projects with corporate or municipal financing, and projects involving public-private partnerships. More generally, the project P can be any project where fund pooling between one or multiple funders is possible. The nature and purpose of the project P can be at the project creator's discretion and other users of the fundraising application are potential funders or donors for the project P. The funding function allows multiple users to select one or more projects to fund. Users can be both project creators and funders.

It is important to note that the created project P can include one or more project requirements PR. The project requirements PR allow the project creator PC to determine conditions that are necessary to successfully fund a project P. For example, a project requirement PR includes a target funding minimum, a minimum amount for the project P to be successfully completed. The default value of the funding minimum can be set to zero.

It is also important to note that each of the users F₁-F_{N} selecting the project P to fund can also establish funder rules FR₁-FR_{N} directed to the selected project P. The funder rules FRᵢ allow each funder Fᵢ to impose conditions that must be met to release funds to the project P. In other words, the funder rules FR₁-FR_{N} give funders F₁-F_{N} direct control over whether or not to fund a project P depending on the circumstances and details of the funding.

For each of the selected projects P, the project requirements PR of the selected project P and the funder rules FR₁-FR_{N} directed to the same project P are processed to determine the current and anticipated funding levels of the selected project P. The funding levels can be shown to other online users who may be motivated to contribute to a project due to the displayed funding levels, such as when a project is close to meeting its funding minimum level. Based on the processing, funds from one or more of the selecting users are transferred to the project P. For the example shown in FIG. 1, based on the funding rules FR₂ and FR_{N} and the project requirements PR, funds from funder FR₂ and funder FR_{N} are released 110 to the project P. However, funder F₁ has imposed restrictive funder rules FR₁ that prevent the funds from funder F₁ to be transferred to fund the project P.

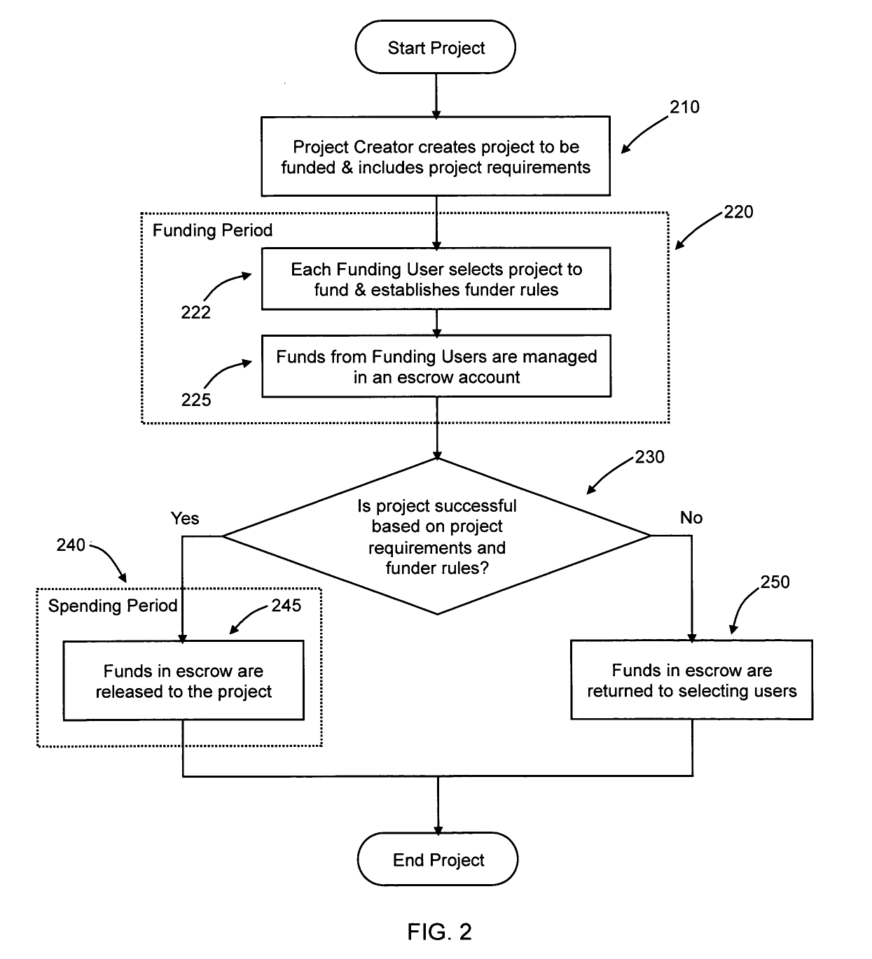

FIG. 2 shows a flow chart of an example project life cycle. A project creator creates a project to be funded, including project requirements 210. After creation, a project enters a funding period 220 where users can select the project to fund and establish funder rules 222. Optionally, the selecting users also enter financial account information to facilitate the transfer of funds. In a preferred embodiment, the funds from the selecting users are transferred to and managed in an escrow account 225. The processing of the project requirements and the funder rules is used to determine if the project is and/or will be successful 230. If a project is successful, the project enters a spending period 240 and the funds in escrow are released to the project 245. If a project is not successful, the funds in escrow are returned to the selecting users. The success or failure of a project can depend specifically on each selecting user, as in the example situation shown by FIG. 1. In an example, success is determined if a current funding level is greater than or equal to the target funding minimum of a project. In certain cases, the spending period 240 and the funding period 220 can at least partially overlap in time.

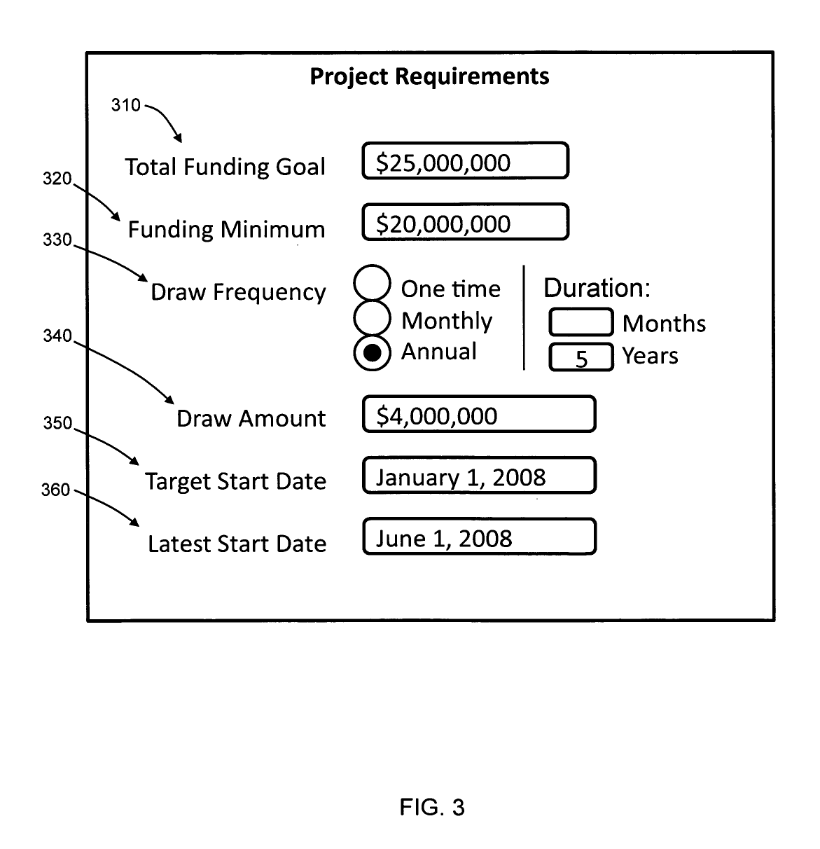

FIG. 3 shows examples of project requirements in a preferred embodiment, including a total funding goal 310, a funding minimum 320, a draw frequency 330, a draw amount 340, a target start date 350, and a latest start date 360. The total funding goal 310 is the amount the project creator hopes to raise for the project and the funding minimum 320 is the minimum amount necessary for the project to proceed. The draw frequency 330 enables a project to have multiple draws over a duration 335 of time. The draw amount 340 is the amount for each of the multiple draws. For example, a draw amount 340 can be drawn monthly or annually. Multiple draws may be desirable for projects that can be broken up into multiple stages. By allowing multiple draws, a project may more easily achieve adequate funding levels as it can be easier to raise many small sums than one larger sum. The target start date 350 is the date the project creator targets for the project to be successfully funded and for the spending period to commence. The latest start date 360 is the latest date for a project to be funded. Obviously, the latest start date 360 must be on or after the target start date 350. Other project requirements, not listed in FIG. 3, can also be used.

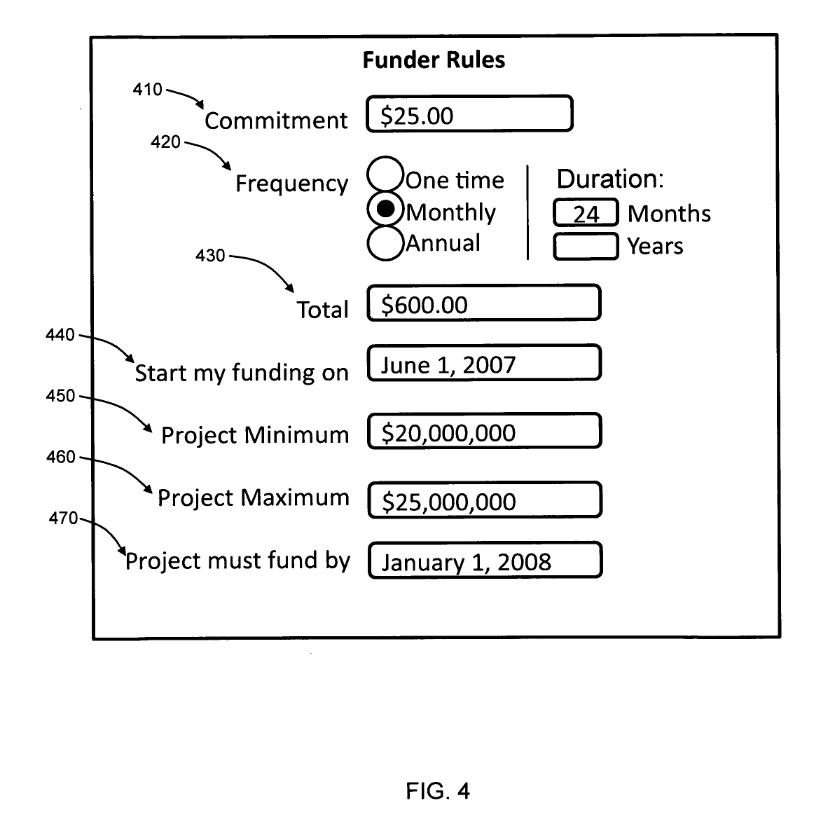

FIG. 4 shows examples of funder rules, including a commitment 410, a payment frequency 420, a total 430, a start funding date 440, a project minimum 450, a project maximum 460, and a project fund by date 470. Similar to the project requirements, the funder rules can enable multiple payments over a duration 425 of time. When multiple payments are selected, the commitment 410 is the amount per payment and the total 430 is determined by the number of payments multiplied by the commitment 410. Alternatively, the total 430 and the duration 425 can be entered and the commitment 410 will be calculated based on these entries. In another option, the commitment 410 and the total 430 can be entered and the duration 425 is calculated. The project minimum 450 and the project maximum 460 provide boundaries for the total funding goal 310 and/or the funding minimum 320 of the project requirements. The project fund by date 470 establishes a time condition that a project must meet for funds from the user establishing the funder rules to be released to the project.

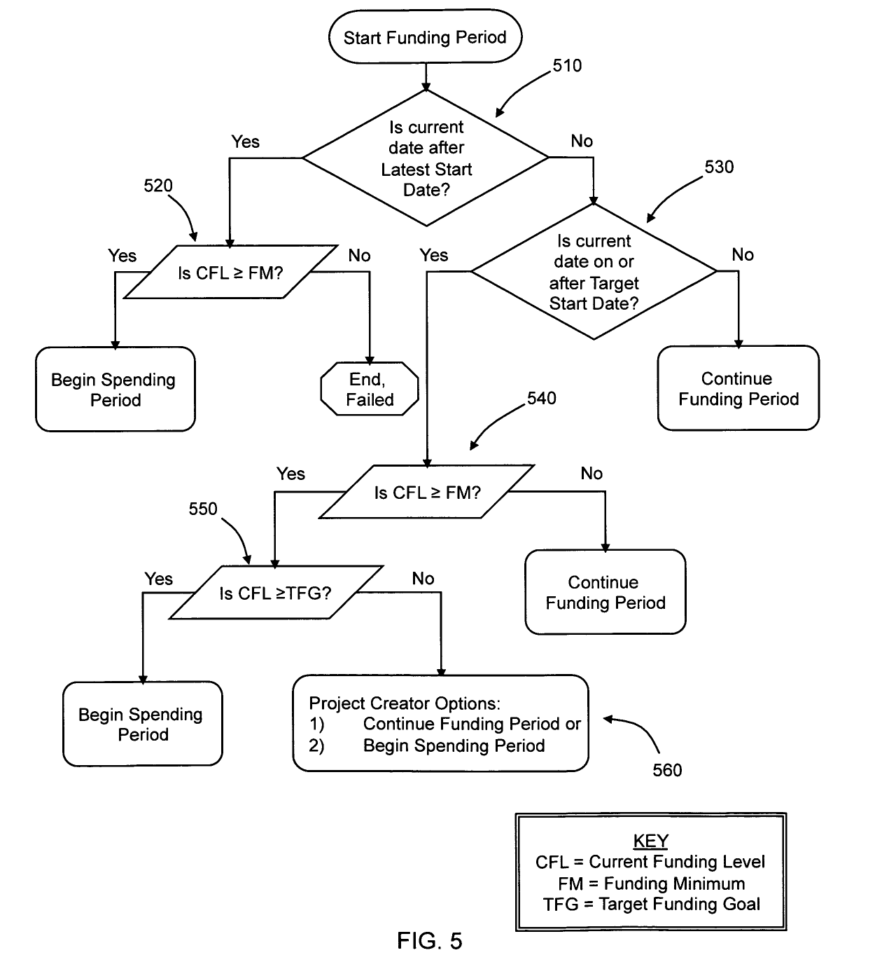

The processing of the project requirements and the funder rules determines if a project is or will be adequately funded. FIG. 5 shows a flow chart of example conditions to be processed for determining the success of a project in a preferred embodiment. During the funding period, funding levels on the current date (or any other date) is compared against the latest start date 510 and the target start date 530. For example, if the current date is after the latest start date, then the current funding level CFL is compared 520 with the funding minimum FM. The CFL is determined by an aggregate of the funder rules, including commitment amounts, calculated for the project being processed. If the CFL exceeds or is equal to the funding minimum 520, the project can be considered successfully funded and funds are released to the project, else the project has failed.

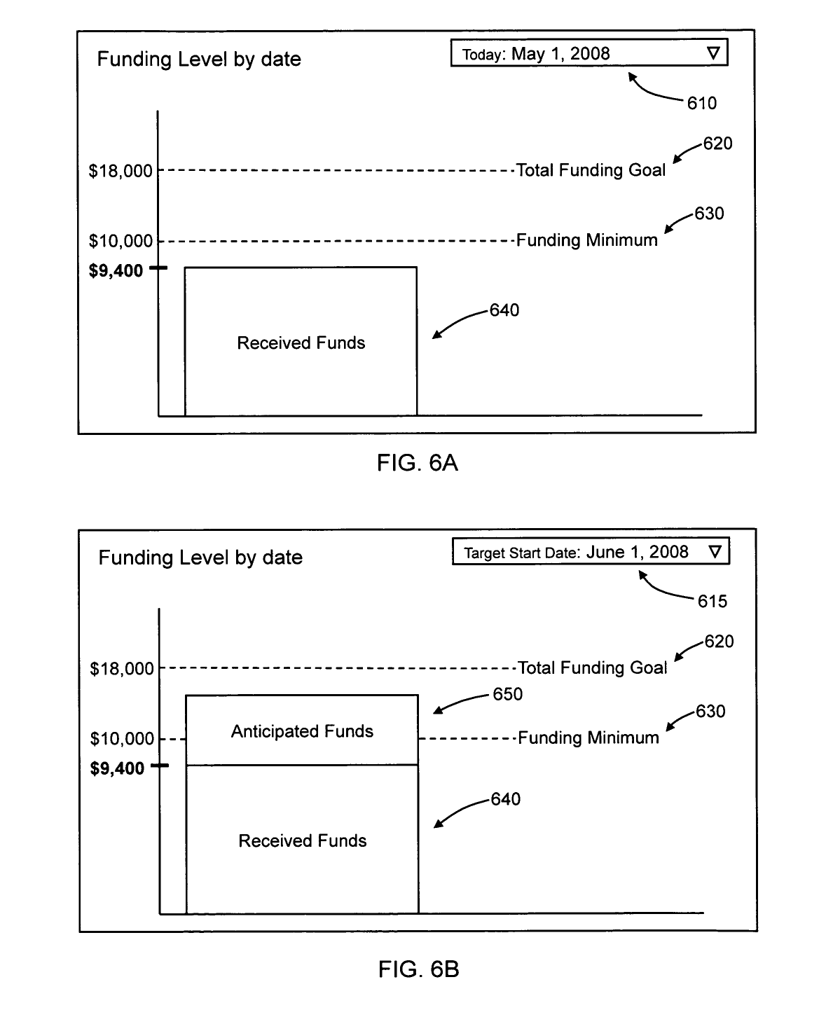

If the current date is before the target start date, the funding period continues until the target start date arrives. However, if the current date is between the latest start date and the target start date, the CFL and FM are again compared 540. If the FM has not been reached by the aggregate of funds, the funding period continues. If the CFL meets or exceeds the FM, the CFL is further compared with the total funding goal TFG to see if the CFL is equal to or greater than the TFG 550. If this condition is met, the project is successfully funded and the spending period commences. For the scenario in which the CFL lies between the FM and the TFG, the project creator is given the option to continue the funding period and/or begin the spending period 560. Other conditions based on the funding requirements and funder rules, in addition to or in replacement of one or more conditions shown in FIG. 5, can also be used. The current and anticipated funding levels, based on the project requirements and funder rules, can also be displayed to the online users, including the project creator and the selecting users. In an exemplary embodiment shown in FIG. 6A, a chart is provided for displaying the current funding level available on a date selected by a drop down menu 610. The chart displays the amount of received funds 640 from the aggregate of funders. The received funds 640 are shown in comparison with the funding minimum 630 and the total funding goal 620. Another example chart for the same project is provided in FIG. 6B for a future date selected by the drop down menu 615. In addition to the received funds, anticipated funds 650 are displayed.

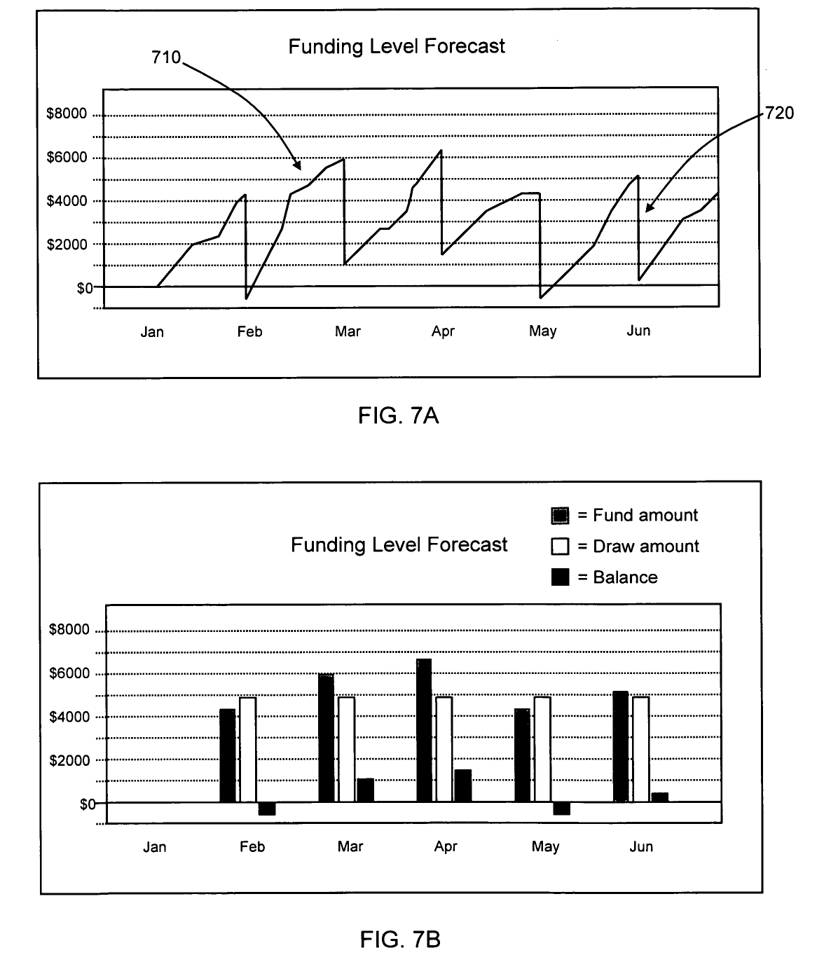

For projects with multiple draws, the funding level forecast can be more complicated. An exemplary embodiment of a funding level forecast is shown in FIG. 7A for a project with multiple (monthly) draws. The line chart shows the funding level 710 during different periods of time. Sharp drops 720 in the funding level 710 indicate the monthly occurrence when funds are released to the project. When the funding level 710 is negative, as seen for February and May, funding gaps exist where more funds are required to meet the funding minimum or funding goal. FIG. 7B shows an exemplary funding level bar chart corresponding to the line chart of FIG. 7A.

For projects with single or multiple draws, processing the funder rules to determine the funding level at any given moment of time is calculated by the funder rules. However, the calculation may give non-unique results depending on the order in which the contributions from different sets of funder rules are calculated. For example, at the beginning of a given day a project may have a current funding level of $280. A first funder establishes first funder rules with a commitment of $30 and a funding minimum of $300. A second funder establishes second funder rules with a commitment of $11. A third funder establishes third funder rules with a commitment of $20 and a funding maximum of $290. If processed in order from first funder rules to third funder rules, only $11 will be contributed due to the limitations placed by the funding minimum of the first funder rules and the funding maximum of the third funder rules. However, if the third funder rules are processed first, a larger contribution of $61 can be added.

The disparity in contributions shown by the above simple example illustrates that there are optimal conditions to achieve the highest funding levels for a project. In a preferred embodiment, a project is processed to find optimal or approximate optimal conditions to reach or exceed the target funding minimum. Intelligent algorithms, such as “greedy” algorithms, can be used to iteratively find approximate optimal conditions. In the greedy algorithm, initially each funder rules is processed with the assumption that all other funder rules are satisfied. The funder rules that are not satisfied even with this assumption are then discarded and the remaining funder rules are processed with the same assumption. The algorithm is continued iteratively until no further funder rules are discarded and the funding level results become stable between iterations. The greedy algorithm removes the dependency of the funding level on the order of processing the funder rules.

Further complications and degrees of freedom can exist for projects with multiple draws; when multiple draws are allowed, the funding level can be a function of the draw date. For example, a project having monthly draws can have a funding level depending on if the funds are drawn on the 1^{st} of the month or the 15^{th} of the month. Algorithms to optimize or approximately optimize the draw date to find the draw date that gives the largest funding level can be employed.

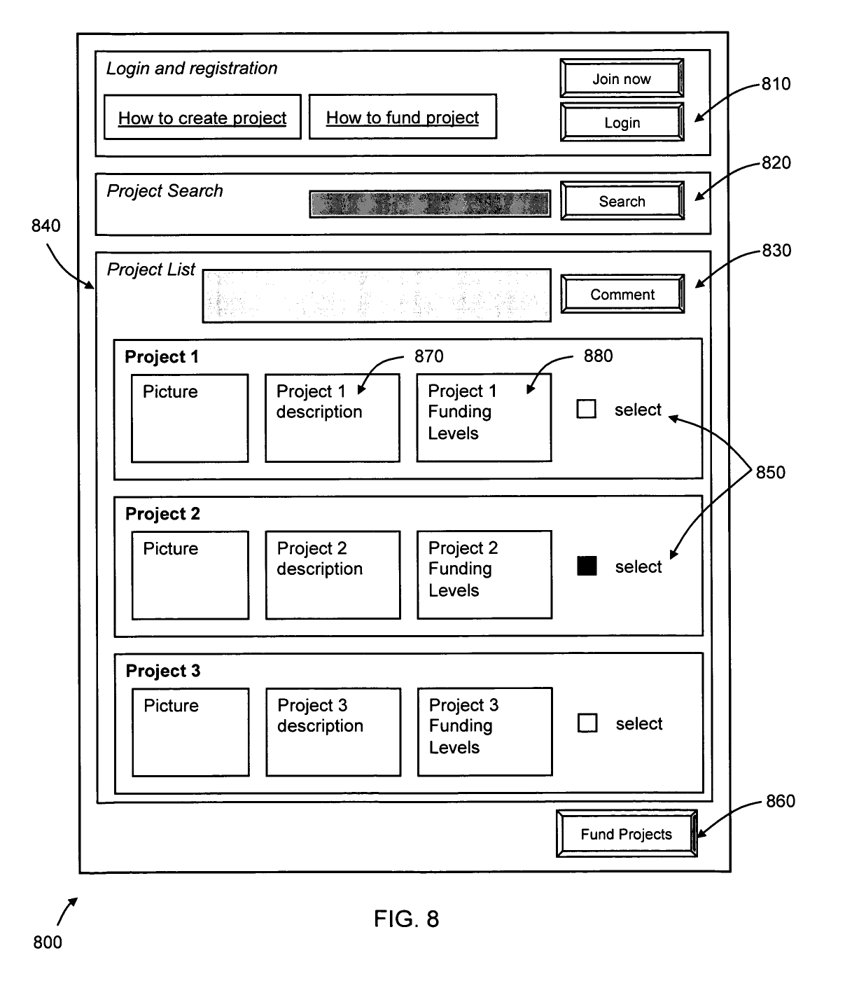

FIG. 8 shows an example of a user interface 800, preferably viewable on a web browser, for operating the interactive fundraising application. The application can require registration and for users to log in 810 to use the application. A project list 840 is provided for users to view details of created projects, such as project descriptions 870 or funding levels 880. The created projects can be selected 850 to be funded 860. After selection 850 of a project, the selecting users can establish funder rules for the project. Users can also search 820 for projects based on criteria such as project creators, project types, descriptions, amounts, dates, or any combination thereof. A commenting function 830 can also be available for users to enter comments regarding projects or other users. Other networking functions, such as web bulletins, blogs, forums, chats, video chats, and messaging functions, can also be incorporated with the fundraising application.

As one of ordinary skill in the art will appreciate, various changes, substitutions, and alterations could be made or otherwise implemented without departing from the principles of the present invention, e.g. the Internet could be substituted by a local area network and other conditions can be used as project funding requirements and/or funder rules. Accordingly, the scope of the invention should be determined by the following claims and their legal equivalents.

What is claimed is:

1. A method for project fundraising with a plurality of online users, comprising:
(a) providing a project creation function for allowing each of said online users to create one or more projects to be funded, wherein each of said created projects can include one or more project requirements, wherein said project requirements comprises a target funding minimum;
(b) providing a funding function for allowing each of said online users to select one or more of said created projects, wherein multiple of said online users can select the same of said created projects, wherein said funding function allows each of said selecting users to establish one or more funder rules directed to said selected project;
(c) for each of said selected projects, processing said funder rules of the same of said selected projects, wherein said processing comprises determining a current funding level and comparing said current funding level with project requirements of the same of said projects; and
(d) at least partially funding one of said selected projects based on said comparison of said current funding level and said project requirements, wherein said funding is from said one or more users who selected the same of said selected projects.

2. The method as set forth in claim 1, wherein said project requirements comprises a total funding goal, a target start date, a latest start date, a draw frequency, a project duration, and a draw amount.

3. The method as set forth in claim 1, wherein said funder rules comprises a commitment, a payment frequency, a payment duration, a start funding date, a project minimum, a project maximum, and a project fund by date.

4. The method as set forth in claim 1, wherein said processing of one of said selected projects comprises finding approximate optimal conditions to reach said target funding minimum based on said project requirements of the same of said selected projects and said funder rules directed to the same of said selected projects.

5. The method as set forth in claim 1, wherein said processing comprises determining an anticipated funding level for each of said selected projects, said method further comprising displaying said current funding level and said anticipated funding level of at least one of said created projects to at least one of said online users.

6. The method as set forth in claim 1, further comprising posting a list of created projects to said online users, wherein said funding function allows each of said users to select one or more created projects from said list.

7. The method as set forth in claim 1, further comprising receiving financial account information for one of said selecting users.

8. The method as set forth in claim 1, further comprising managing an escrow account for one of said selected projects, wherein said escrow account is for holding a funding commitment of said users selecting the same of said selected projects.

9. The method as set forth in claim 8, wherein said funding commitment held by said escrow account is transferred based on said processing said funder rules directed to the same of said selected projects, wherein said funding commitment is transferred to fund the same of said selected projects if said current funding level is greater than or equal to said target funding minimum of the same of said selected projects, else said funding commitment is returned to said users selecting the same of said selected projects.

10. The method as set forth in claim 1, further comprising providing a commenting function for said online users to comment on one or more of said created projects.

11. A system for project fundraising, comprising:
(a) an application server for operating an internet-based fundraising application for a plurality of online users;
(b) a project creation function for allowing each of said online users to create one or more projects to be funded, wherein each of said created projects can include one or more project requirements, wherein said project requirements comprises a target funding minimum;
(c) a funding function for allowing each of said online users to select one or more of said created projects, wherein multiple of said online users can select the same of said created projects, wherein said funding function allows each of said selecting users to establish one or more funder rules directed to said selected projects;
(d) a processing function for processing said funder rules for each of said selected projects, wherein said processing comprises determining a current funding level and comparing said current funding level with said project requirements of the same of said projects; and
(e) a fund transfer function for at least partially funding one of said selected projects based on said comparison of said current funding level and project requirements of the same of said selected projects, wherein said funding is from said one or more users who selected the same of said selected projects.

12. The system as set forth in claim 11, wherein said project requirements comprises a total funding goal, a target start date, a latest start date, a draw frequency, a project duration, and a draw amount.

13. The system as set forth in claim 11, wherein said funder rules comprises a commitment, a payment frequency, a payment duration, a start funding date, a project minimum, a project maximum, and a project fund by date.

14. The system as set forth in claim 11, wherein said processing of one of said selected projects comprises finding approximate optimal conditions to reach said target funding minimum based on said project requirements of the same of said selected projects and said funder rules directed to the same of said selected projects.

15. The system as set forth in claim 11, wherein said processing function determines an anticipated funding level for each of said selected projects, said system further comprising a display function for displaying said current funding level and said anticipated funding levels of at least one of said created projects to at least one of said online users.

16. The system as set forth in claim 11, further comprising a list of created projects, wherein said list of created projects is viewable by said online users, wherein said funding function allows each of said users to select one or more created projects from said list.

17. The system as set forth in claim 11, further comprising a database for storing financial account information of one of said selecting users.

18. The system as set forth in claim 11, wherein said application server manages an escrow account for one of said selected projects, wherein said escrow account is for holding a funding commitment of said users selecting the same of said selected projects.

19. The system as set forth in claim 18, wherein said funding commitment held by said escrow account is transferred based on said processing said funder rules directed to the same of said selected projects, wherein said funding commitment is transferred to fund the same of said selected projects if said current funding level is greater than or equal to said target funding minimum of the same of said selected projects, else said funding commitment is returned to said users selecting the same of said selected projects.

20. The system as set forth in claim 11, further comprising a commenting function for said online users to comment on one or more of said created projects.
